(19) United States
(12) Patent Application Publication
(10) Pub. No.: US 2014/0198340 A1
(43) Pub. Date: Jul. 17, 2014

(54) SYSTEMS AND METHODS FOR EXPANSION OF CLOUD SOLUTIONS TO LOCAL COMPUTERS TO OVERCOME BANDWIDTH LIMITATIONS

(71) Applicant: GLOBAL GRAPHICS SOFTWARE LIMITED, Cambridge (GB)

(72) Inventor: Martin Paul Bailey, Cambridge (GB)

(73) Assignee: GLOBAL GRAPHICS SOFTWARE LIMITED, Cambridge (GB)

(21) Appl. No.: 13/741,082

(22) Filed: Jan. 14, 2013

(51) Int. Cl. G06F 3/12

(52) U.S. Cl. CPC G06F 3/1286
USPC 358/1.15

(57) ABSTRACT

A method of managing printing of documents includes receiving documents at a cloud processing arrangement external to a local network; rendering the documents into rasters at the cloud processing arrangement; delivering the rasters to at least one printer of the local network; monitoring delivery of the rasters; and when delivery of the rasters fails to meet a threshold condition, diverting at least some portion of the documents to at least one server of the local network for rendering of those documents into rasters and for delivering those rasters to the at least one printer of the local network.

### FIELD

The invention relates to systems and method for managing processes using cloud and local solutions to overcome bandwidth limitations. For example, the invention can be used in systems and method for managing the processing of documents for printing using cloud and local solutions that vary with changing bandwidth usage.

### BACKGROUND

In recent years advances in local and wide-area networking, including increased bandwidth and reliability, have opened up the potential in a number of fields of computing to perform processing at remote locations, often described as “in the cloud”. Such processing can include, for example, processing (e.g., rendering or rasterizing) documents for printing.

Cloud solutions may be either ‘private’, meaning that their infrastructure is provided and maintained by the same organization as the user of the services, or ‘public’ meaning that they are provided and serviced by a third party supplier. They can also be divided into ‘on-premise’ or ‘local’ solutions, where the required computing hardware is physically located within the user organization's firewall (i.e., within the user organization's local network), and ‘off-premise’ or ‘external’, where the hardware is at a location remote to the user (in a geographic or network sense). There is a tendency to assume that ‘private’ and ‘on-premise’ are equivalent, and the same for ‘public’ and ‘off-premise’, but there are certainly situations in which that assumption is incorrect.

There are also hybrid processing solutions that combine on- and off-premise components. Conventional methods have typically been aimed at reducing the cost of delivering services against a very variable demand. It is often appropriate to provision sufficient on-premise platforms to address at least a lowest level of computing demand, and often a little more. Then, when demand peaks, the excess processing requirements can be off-loaded to off-premise servers. This model is often driven by the comparative costs of capital investments and incremental usage costs of on- and off-premise solutions. If equipment will be fully and continuously utilized then the total cost of acquisition and use is usually lower for on-premise solutions. If equipment would only be fully used under peak demand, but would be only partially used or completely unused at other times, then it is often cheaper to contract out that requirement on a pay-per-use model. Those calculations, however, make two assumptions; 1) a service can be provided more cheaply using an on-premise solution, and 2) the only resource that needs to be taken into account is the processing capability.

### BRIEF SUMMARY

One embodiment is a method of managing printing of documents. The method includes delivering documents to a cloud processing arrangement for rendering the documents into rasters at the cloud processing arrangement and delivering the rasters to at least one printer of a local network; monitoring delivery of the rasters; and when delivery of the rasters fails to meet a threshold condition, diverting at least some portion of the documents to at least one server of the local network for rendering of those documents into rasters and for delivering those rasters to the at least one printer of the local network.

A further embodiment is a method of managing printing of documents. The method includes receiving documents at a cloud processing arrangement; rendering the documents into rasters at the cloud processing arrangement; delivering the rasters to at least one printer of a local network; monitoring delivery of the rasters; and when delivery of the rasters fails to meet a threshold condition, diverting at least some portion of the documents to at least one server of the local network for rendering of those documents into rasters and for delivering those rasters to the at least one printer of the local network.

Another embodiment is a computer readable storage medium having processor-executable instructions, the processor-executable instructions when installed onto a system enable the system to perform actions. The actions include delivering documents to a cloud processing arrangement for rendering the documents into rasters at the cloud processing arrangement and delivering the rasters to at least one printer of a local network; monitoring delivery of the rasters; and when delivery of the rasters fails to meet a threshold condition, diverting at least some portion of the documents to at least one server of the local network for rendering of those documents into rasters and for delivering those rasters to the at least one printer of the local network.

A further embodiment is a computer readable storage medium having processor-executable instructions, the processor-executable instructions when installed onto a system enable the system to perform actions. The actions include receiving documents at a cloud processing arrangement ; rendering the documents into rasters at the cloud processing arrangement; delivering the rasters to at least one printer of a local network; monitoring delivery of the rasters; and when delivery of the rasters fails to meet a threshold condition, diverting at least some portion of the documents to at least one server of the local network for rendering of those documents into rasters and for delivering those rasters to the at least one printer of the local network.

Yet another embodiment is a system for managing printing of documents. The system includes a local network having at least one local device, at least one printer, at least one local server, and at least one processor. The at least one processor is configured and arranged to deliver documents from by the at least one local device of the local network to a cloud processing arrangement external to the local network for rendering the documents into rasters at the cloud processing arrangement and delivering the rasters to the at least one printer of the local network; monitor delivery of the rasters; and when delivery of the rasters fails to meet a threshold condition, divert at least some portion of the documents to the at least one local server of the local network for rendering of those documents into rasters and for delivering those rasters to the at least one printer of the local network.

A further embodiment is a system for managing printing of documents. The system includes a non-transitory memory storage device; and at least one processor coupled to the memory storage device. The at least one processor is configured and arranged to receive documents; render the documents into rasters; deliver the rasters to at least one printer of a local network, wherein the at least one processor of the system is external to the local network; monitor delivery of the rasters; and when delivery of the rasters fails to meet a threshold condition, divert at least some portion of the documents to at least one server of the local network for rendering of those documents into rasters and for delivering those rasters to the at least one printer of the local network.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic representation of one embodiment of an environment in which the invention can be employed;

FIG. 2 is a schematic representation of one embodiment of a local network and a cloud processing arrangement, according to the invention;

FIG. 3 is a schematic flow chart of one embodiment of managing printing of documents using a cloud and at least one local server, according to the invention

FIG. 4 is a schematic flow chart of another embodiment of managing printing of documents using a cloud and at least one local server, according to the invention; and

FIG. 5 is a schematic flow chart of a third embodiment of managing printing of documents using a cloud and at least one local server, according to the invention.

### DETAILED DESCRIPTION

The invention relates to systems and method for managing processes using cloud and local solutions to overcome bandwidth limitations. For example, the invention can be used in systems and method for managing the processing of documents for printing using cloud and local solutions that vary with changing bandwidth usage.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The following detailed description is, therefore, not to be taken in a limiting sense. Systems and devices reference herein typically include mass memory and typically include methods for communication with other devices including mobile devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a processor.

Methods of communication can include both wired and wireless (e.g., RF, optical, or infrared) communications methods and such methods provide another type of computer readable media; namely communication media. Communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

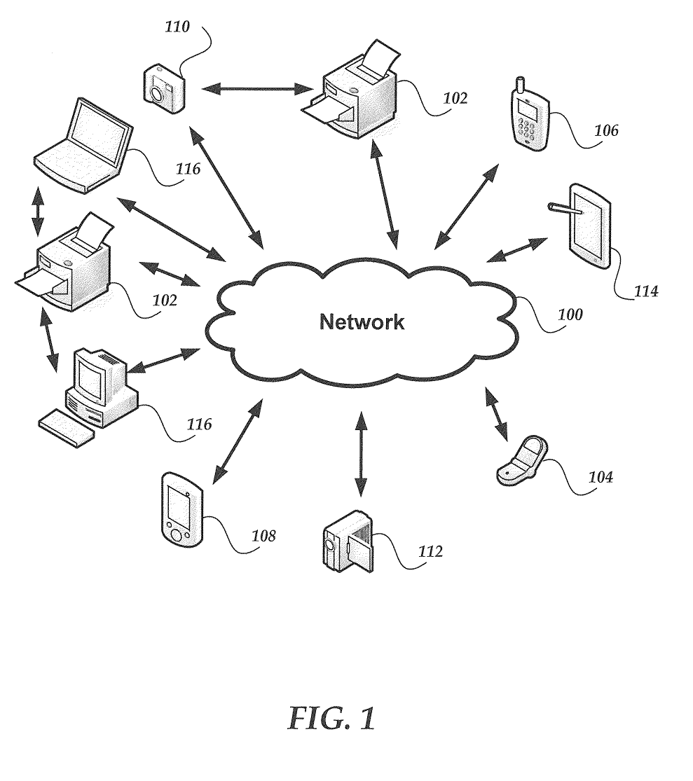

FIG. 1 illustrates one embodiment of an environment for the invention. It will be understood that the network environment can include a local area network, a wide area network, or any combination thereof. It will also be understood that the network can include devices, other than those illustrated, coupled to the network and that there may be multiple devices of each type illustrated connected to the network.

The illustrated environment of FIG. 1 includes a network 100 to which is attached, either directly or through other devices, and computers/servers 116 (e.g., desktop or laptop computers or servers), one or more printers or presses 102, cell phones 104, smart phones 106, personal data assistants (PDA's) 108, cameras 110, video cameras 112, or tablet or slate computers 114. Unless otherwise indicated, the terms “printer” and “press” are used interchangeably herein. Other devices can optionally be attached to the network such as portable storage devices (e.g., compact discs, DVDs, memory sticks, flash drives, or other optical or magnetic storage media) and the like. Any of these devices can be connected directly to the network or via another device. A device can optionally be connected directly to a printer 102 through a wired or wireless connection or can be connected to the printer through the network or both directly and through the network. Attachment to the network or to devices in the network can be wired or wireless connection or any combination thereof.

The printer or press may include a processor that can process the document and a memory unit for storage of the documents or portions of the document. The printer or press includes a print engine for printing the document.

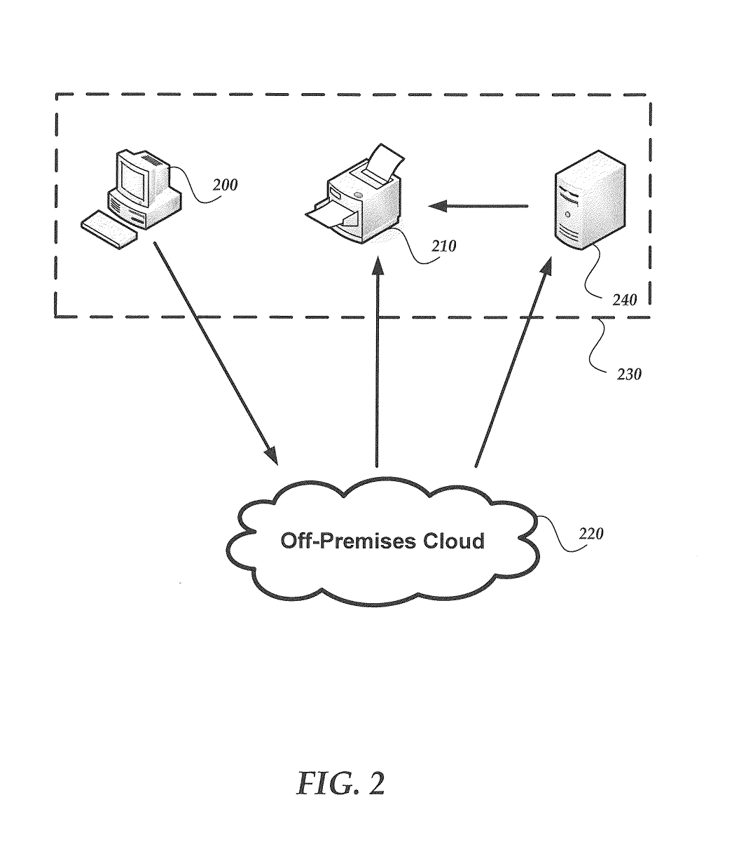

FIG. 2 illustrates an environment for rendering a document from a page description language (PDL) prepared at a device 200, such as a computer, PDA, tablet or slate computer, smart phone, camera, video camera, and the like, in order to drive a digital production printer or press 210. In at least some embodiments, both the device 200 and the printer/press 210 are part of a local network 230 (for example, a network entirely within the user's firewall). In at least some embodiments, the document is typically sent from the device 200 to an off-premise cloud 220 (i.e., a cloud processing arrangement external to the local network) for rendering and then the rendered document is sent to the printer/press 210 for printing.

In at least some embodiments, the off-premise cloud may be operated by a digital printer vendor. This arrangement might be a part of an offering from the digital printer vendor. Such offering may provide advantages such as, for example, a) rendering using solutions as easy as possible for a digital print service provider to implement, especially if it's combined with a variety of other offerings from the same solution, such as web to print, document composition, imposition, and the like; b) charging from the vendor to the user that may be simplified down to just a click-charge; c)variability in performance and variation in hardware and operating system versions can be eliminated, thus reducing the cost of support for the vendor; and d) users can be kept up to date with the latest releases from the vendor at the lowest cost to both.

One challenge for such a process in the cloud is that a single 8.5×11 page at the commonest resolution for digital production printers (600 dots per ink, or dpi) in full color (using the common four printing colorants Cyan, Magenta, Yellow and Black, or CMYK) as an 8-bit per pixel contone can result in a raster file of about 128 MB. Thus a printer running at 100 pages per minute (ppm) should receive approximately 12.5 GB of raster data per minute, or 1712 megabits per second (mbps) for full utilization. Reliably sustaining that data rate across an external data connection can be a significant challenge.

The data rate can be reduced by a number of techniques including, for example, halftone screening and compression. Screening to a 1 bit per pixel halftone may reduce the data rate for an uncompressed raster by a factor of, for example, 8, to only 1.5 GB/min, at the cost of a potential reduction in the effectiveness of compression, but even this is still approximately 214 mbps for a single printer.

The effect of compression varies according to the content of the page. While it is usually quite effective, in the worst case most compression techniques can actually increase the size of the data to be transmitted, and systems may choose to deliver uncompressed data instead.

In addition, in at least some instances there may be a requirement to encrypt the raster data for delivery to avoid interception of sensitive documents being printed. That would normally be performed after compression and is likely to increase the data size again very slightly.

If raster delivery from the cloud 220 to the print site (i.e., printer 210) cannot keep up with the speed of the printer (or printers) being used at that site then the printer(s) will likely stop and wait for additional data before continuing, thus reducing productivity. When each printer is taking cut-sheet media (for example, pages of paper) from an input tray this is usually relatively easy to do without wasting materials; for example, the printer can simply be stopped between sheets. If the printer is taking continuous media from a roll, however, stopping and starting the printer will often waste media because the roll cannot be stopped and started instantaneously, and the printer can only print when the media is moving at a stable speed. Waste media between printed areas may also complicate finishing operations (cutting, collating, folding, etc). Even when stopping and starting production does not lead directly to increased wastage of media, it does lead to reduced productivity.

The desirable data rate to the print site can be reduced if more than one copy of every page is to be printed. Thus, if 200 copies of a 12-page brochure are to be printed on a 100 ppm printer, the total printing time will be 24 minutes (200×12/100). In that time only 12 pages worth of raster data is delivered, and each page raster will be delivered to the marking engine of the printer 200 times. A slow data connection may be used in this situation. If it is of moderate speed then the rasters for all pages of a second job could be downloaded while the first job is being printed; the only negative impact of a slow download speed may be a delay before starting the printers themselves. Use of a very slow data connection may introduce additional delays before subsequent jobs to be sent to the same printer.

One of the advantages of a digital printing workflow, however, is that the printer can produce different output on every page, unlike a traditional press using technology such as offset litho, flexography, gravure and the like. Thus there is continuing pressure towards smaller and smaller numbers of copies of every page to be printed, and towards the use of variable data printing, where pages are routinely personalized or customized in some way, often for each recipient of a direct mail campaign, for instance. This reduces the likelihood that a large number of copies of a single document or page will be requested.

While the example of cloud-based rendering is used herein, the challenges raised by delivery bandwidth are applicable to other processes as well. The systems and methods described herein are useful or adaptable to these other processes.

In at least some embodiments, such as that illustrated in FIG. 2, the default operational approach in a cloud rendering solution is to provide a document from device 200, render the document in the cloud 220, and to deliver the rendered rasters to a printer 210 for printing in something close enough to real-time to avoid significant loss of productivity.

In at least some embodiments, this default approach is re-assessed periodically (at regular or irregular intervals and optionally for each printer when a group of printers is coupled to the cloud 220). This re-assessment may be performed in the cloud 220 by the vendor or in the local network 230 by the vendor or user. This reassessment can be based on information related to one or more factors (or any combination of these factors) including, but not limited to, the historical data rate achieved between the cloud-based rendering system and the print site; the run length (number of copies to be printed) of upcoming jobs in the queue for that printer or printers; the amount by which compression has been able to reduce raster sizes for each job; the number of printer(s) in use at the relevant site; whether any of those printers are roll-fed rather than sheet-fed; whether that site can receive rasters for upcoming jobs during times at which the printers are not running (e.g. overnight); or any additional solution-specific technical factors such as the effectiveness of mechanisms designed to reduce the amount of raster data delivered to the print site.

The results of this analysis may indicate that the data rate to the print site is not sufficient to, for example, support a desired level of productivity. If the desired data rate is inadequate then processing for some or all jobs can be transitioned to a locally installed rendering solution, such as rendering software on a local server 240 on the local network 230, instead of being performed in the cloud 220.

In some embodiments, a system may react to such a situation immediately. In other embodiments, the system may track the frequency of such occurrences over time and react after a frequency or duration threshold has been met. One or more different thresholds may be defined to induce reaction in the system. One example of a threshold is if the data rate falls below a desired level for some set proportion of time over the previous period then processing will be transitioned to the local site. Another example is if the data rate falls below a lower threshold level at least some of the rendering or other processing will be transitioned to the local server 240.

Provisioning and installation of that local server may be achieved by a variety of approaches, including, but not limited, to: a) installation of software onto a server by the solutions provider and physical shipping of the server to the print site; b) installation of software provided by the vendor onto a server provided by the user; c) installation of software provided by the vendor as a virtual machine on a server provided by the user and local to the print site; or d) automated or semi-automated delivery and installation of software to the print site using the same data network as is used for raster delivery.

In at least some embodiments, the software installed local to the print site is licensed implicitly or explicitly as a part of the cloud solution offering. Explicit licensing could include, for example, the local installation being identified as in use at a specific print site associated with a specific rendering agreement and may be in direct communication to a license server maintained by the cloud solution provider. Implicit licensing could be implemented by, for example, restricting the solution in such a way that it could accept input jobs only from the solution provider's cloud service, or in such a way that it can deliver rasters only to the hardware or software components that would otherwise receive rasters from the cloud rendering service.

The original PDL file is often substantially smaller than full-page rasters for the pages that it describes (or can be relatively easily arranged to be smaller by, for example, reducing the resolution of embedded images to a level appropriate for printing, or by sub-setting CJK fonts). Thus a communications channel that cannot achieve the data rates required to deliver raster data may well be able to support delivery of PDLs for local rendering.

In at least some embodiments, the arrangement is configured to ensure the integrity of any data sent across the network, including both completeness and correctness of each part. This is desirable whether a job is transmitted as source documents (e.g. a PDF file, perhaps plus fonts, perhaps plus images referenced via OPI etc), or as raster data for each page.

The systems and methods described herein reverse the base expectation of conventional systems that processing will be performed locally unless it is necessary to overflow to an off-premise cloud solution. The majority of work will be performed off-premise, and will only be moved on-premise to the users' own site and equipment when necessary to ensure continued efficient processing. In addition, selection of the location for processing is not primarily determined by short-term economic factors, but by the technical requirements of the job. The example used in this document is the band-width requirement for delivery of page rasters at a high enough rate to achieve full productivity from a printer.

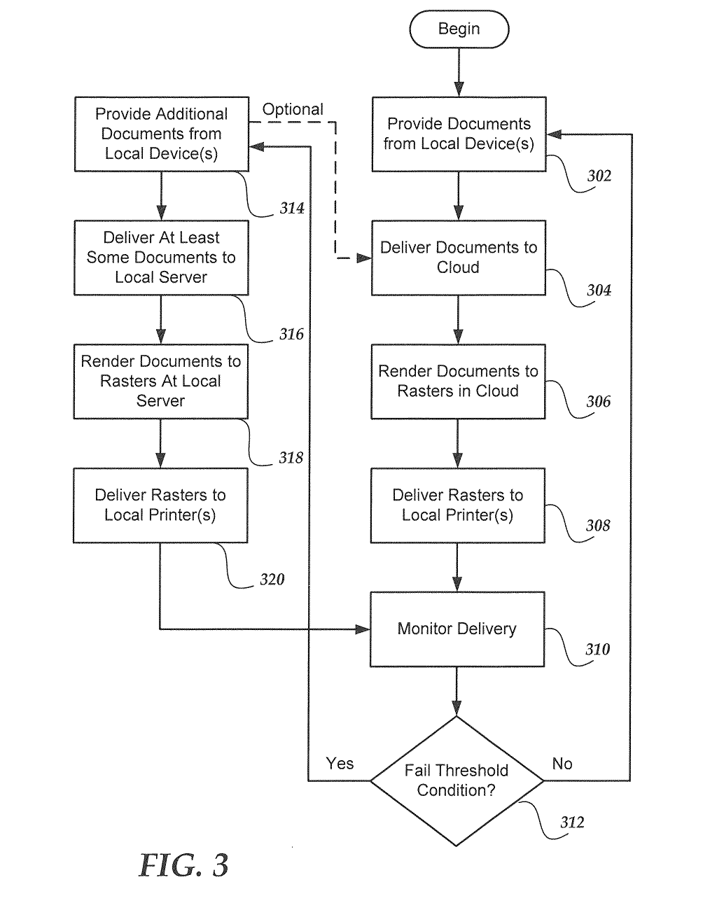

FIG. 3 is a flowchart of at least one embodiment of a method of managing the printing of documents. Documents are provided using one or more local devices of a local network in step 302. In one embodiment, the documents are produced on the local device. In other embodiments, the documents may be produced elsewhere and then provided to a local device.

The documents are delivered to a cloud processing arrangement external to the network in step 304. The cloud processing arrangement renders the documents into rasters in step 306 and delivers the rasters to one or more local printers in the local network in step 308. The delivery of the rasters is monitored periodically (with any regular or irregular period or upon occurrence of some event) or continuously in step 310. Monitoring may include, for example, monitoring the delivery rate of the rasters or the data rate of delivery of the rasters or any other relevant condition or conditions of the delivery. The monitoring may be performed by the local network and the associated user or by the cloud service vendor or by both. In step 312 the delivery of rasters is evaluated to determine if a threshold condition has been failed. Examples of threshold conditions are discussed above, but it will be understood that other threshold conditions may be selected. If there has been no failure, then further documents can be provided to the cloud for processing.

If there is a failure of the threshold condition, then at least some of the additional documents (but not necessarily all of the additional documents) produced using one or more local devices in step 314 are delivered to one or more local servers in the local network in step 316. The local server renders the documents into raster in step 318 and delivers the rasters to local printers 320. Optionally, some of the additional documents may be delivered instead to the cloud processing arrangement (as indicated by the dotted line in FIG. 3) for rendering into rasters and deliver of those rasters to one or more local printers.

The delivery rate of rasters from the cloud processing arrangement may continue to be monitored periodically or continuously and, in at least some embodiments, when delivery no longer fails the threshold condition or, in some embodiments, when the delivery meets a reestablishment condition (which may be different from the threshold condition), the method and corresponding system may revert to sending all documents to the cloud for processing.

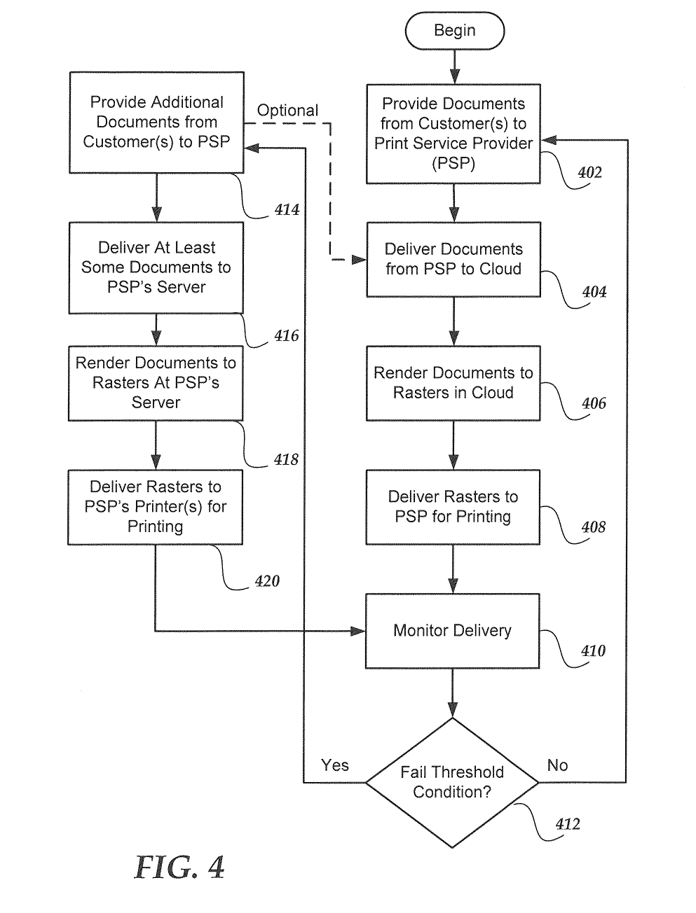

FIG. 4 is a flowchart of another embodiment of a method of managing the printing of documents. Documents are provided from one or more customers to a print service provider (PSP) in step 402. In this embodiment, the local network described above corresponds to the network of the PSP, not the network of the customer(s). The documents are produced by the customer(s) and may be produced outside of the local (i.e., PSP's) network. The PSP may be any service provider that provides processing and, optionally, printing services to the customer(s) including, for example, a service provider that provides web-to-print (W2P) services. The customer(s) may create the documents on the PSP's network or may deliver the documents to the PSP's network in any suitable manner including, but not limited to, delivery over the Internet, delivery using a tangible medium, or delivery using a public or non-public wired or wireless service. It will be recognized that the documents being processed using the methods described herein may be from a single customer or from multiple customers.

The documents are delivered to a cloud processing arrangement external to the PSP's network in step 404. The cloud processing arrangement renders the documents into rasters in step 406 and delivers the rasters to the PSP's network (for example, one or more printers in the PSP's network) in step 408. The delivery of the rasters is monitored periodically (with any regular or irregular period or upon occurrence of some event) or continuously in step 410. Monitoring may include, for example, monitoring the delivery rate of the rasters or the data rate of delivery of the rasters or any other relevant condition or conditions of the delivery. The monitoring may be performed by the PSP's network or by the cloud service vendor or by both. In step 412 the delivery of rasters is evaluated to determine if a threshold condition has been failed. Examples of threshold conditions are discussed above, but it will be understood that other threshold conditions may be selected. If there has been no failure, then further documents can be provided to the cloud for processing.

If there is a failure of the threshold condition, then at least some of the additional customer documents (but not necessarily all of the additional customer documents) in step 414 are delivered to one or more of the PSP's servers in the PSP's network in step 416. The PSP's server renders the documents into raster in step 418 and delivers the rasters to the PSP's printers 420. Optionally, some of the additional documents may be delivered instead to the cloud processing arrangement (as indicated by the dotted line in FIG. 4) for rendering into rasters and deliver of those rasters to one or more of the PSP's printers.

The delivery rate of rasters from the cloud processing arrangement may continue to be monitored periodically or continuously and, in at least some embodiments, when delivery no longer fails the threshold condition or, in some embodiments, when the delivery meets a reestablishment condition (which may be different from the threshold condition), the method and corresponding system may revert to sending all documents to the cloud for processing.

As an alternative to having the documents printed by the PSP's printers, the PSP may deliver the rasters to the customer(s) or to a third party for printing. As an alternative to having the documents rendered by a raster image processor (RIP) on the PSP's local network, the PSP may make use of a RIP at a cloud processing arrangement.

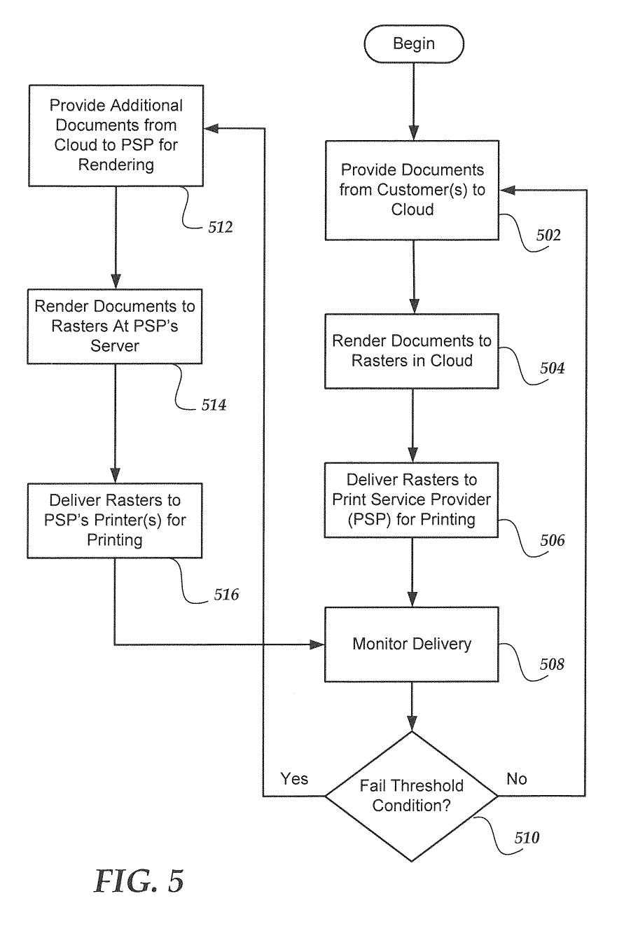

FIG. 5 is a flowchart of a third embodiment of a method of managing the printing of documents. Documents are provided from one or more customers to a cloud service provider (cloud) in step 502. The cloud service provider may be any service provider that provides processing services to the customer(s) including, for example, a service provider that provides web-to-print (W2P) services. In at least some embodiments, the cloud service provider may be actually providing these services to a print service provider (PSP), so that the cloud service provider's interface to the customer may use the PSP's branding. The customer may not be aware that he is interacting with the cloud service provider.

The customer(s) deliver the documents to the cloud in any suitable manner including, but not limited to, delivery over the Internet or delivery using a public or non-public wired or wireless service. It will be recognized that the documents being processed using the methods described herein may be from a single customer or from multiple customers.

The processing arrangement in the cloud renders the documents into rasters in step 504 and delivers the rasters to a print service provider (PSP) in step 506 for printing and delivery to the customer(s). The delivery of the rasters is monitored periodically (with any regular or irregular period or upon occurrence of some event) or continuously in step 508. Monitoring may include, for example, monitoring the delivery rate of the rasters or the data rate of delivery of the rasters or any other relevant condition or conditions of the delivery. The monitoring may be performed by the PSP or by the cloud service provider or by both. In step 510 the delivery of rasters is evaluated to determine if a threshold condition has been failed. Examples of threshold conditions are discussed above, but it will be understood that other threshold conditions may be selected. If there has been no failure, then further documents can be provided to the cloud for processing.

If there is a failure of the threshold condition, then at least some of the additional customer documents (but not necessarily all of the additional customer documents) are delivered by the cloud service provider to one or more of the PSP's servers in the PSP's network for rendering in step 512. The PSP's server renders the documents into raster in step 514 and delivers the rasters to the PSP's printers 516.

The delivery rate of rasters from the cloud processing arrangement may continue to be monitored periodically or continuously and, in at least some embodiments, when delivery no longer fails the threshold condition or, in some embodiments, when the delivery meets a reestablishment condition (which may be different from the threshold condition), the method and corresponding system may revert to sending all documents to the cloud for processing.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A method of managing printing of documents, the method comprising:
delivering documents to a cloud processing arrangement for rendering the documents into rasters at the cloud processing arrangement and delivering the rasters to at least one printer of a local network;
monitoring delivery of the rasters; and
when delivery of the rasters fails to meet a threshold condition, diverting at least some portion of the documents to at least one server of the local network for rendering of those documents into rasters and for delivering those rasters to the at least one printer of the local network.

2. The method of claim 1, wherein monitoring delivery of the rasters comprises monitoring a data rate of delivery of the rasters to the at least one printer.

3. The method of claim 2, wherein the threshold condition is a threshold data rate.

4. The method of claim 1, wherein when delivery of the rasters fails to meet a threshold condition, diverting at least some portion of the documents comprises when a data rate of delivery of the rasters falls below a threshold data rate for more than a threshold period of time, diverting at least some portion of the documents to the at least one server of the local network for rendering of those documents into rasters and for delivering those rasters to the at least one printer.

5. The method of claim 1, wherein when delivery of the rasters fails to meet a threshold condition, diverting at least some portion of the documents comprises when a data rate of the rasters falls below a threshold data rate for more than a threshold proportion of a period of time, diverting at least some portion of the documents to the at least one server of the local network for rendering of those documents into rasters and for delivering those rasters to the at least one printer.

6. The method of claim 1, wherein when delivery of the rasters fails to meet a threshold condition, diverting at least some portion of the documents comprises when a data rate of the rasters falls below a threshold data rate at a frequency exceeding a threshold frequency, diverting at least some portion of the documents to the at least one server of the local network for rendering of those documents into rasters and for delivering those rasters to the at least one printer.

7. The method of claim 1, wherein the local network is a network of a print service provider.

8. A method of managing printing of documents, the method comprising:
receiving documents at a cloud processing arrangement;
rendering the documents into rasters at the cloud processing arrangement;
delivering the rasters to at least one printer of a local network;
monitoring delivery of the rasters; and
when delivery of the rasters fails to meet a threshold condition, diverting at least some portion of the documents to at least one server of the local network for rendering of those documents into rasters and for delivering those rasters to the at least one printer of the local network.

9. The method of claim 8, wherein monitoring delivery of the rasters comprises monitoring a data rate of deliver of the rasters to the at least one printer.

10. The method of claim 9, wherein the threshold condition is a threshold data rate.

11. The method of claim 8, wherein when delivery of the rasters fails to meet a threshold condition, diverting at least some portion of the documents comprises when a data rate of the rasters falls below a threshold data rate for more than a threshold period of time, diverting at least some portion of the documents to the at least one server of the local network for rendering of those documents into rasters and for delivering those rasters to the at least one printer.

12. The method of claim 8, wherein when delivery of the rasters fails to meet a threshold condition, diverting at least some portion of the documents comprises when a data rate of the rasters falls below a threshold data rate for more than a threshold proportion of a period of time, diverting at least some portion of the documents to the at least one server of the local network for rendering of those documents into rasters and for delivering those rasters to the at least one printer.

13. The method of claim 8, wherein when delivery of the rasters fails to meet a threshold condition, diverting at least some portion of the documents comprises when a data rate of the rasters falls below a threshold data rate at a frequency exceeding a threshold frequency, diverting at least some portion of the documents to the at least one server of the local network for rendering of those documents into rasters and for delivering those rasters to the at least one printer.

14. The method of claim 8, wherein the local network is a network of a print service provider.

15. A non-transitory computer readable storage medium having processor-executable instructions, the processor-executable instructions when installed onto a system enable the system to perform actions, comprising:
delivering documents to a cloud processing arrangement for rendering the documents into rasters at the cloud processing arrangement and delivering the rasters to at least one printer of a local network;
monitoring delivery of the rasters; and
when delivery of the rasters fails to meet a threshold condition, diverting at least some portion of the documents to at least one server of the local network for rendering of those documents into rasters and for delivering those rasters to the at least one printer of the local network.

16. A non-transitory computer readable storage medium having processor-executable instructions, the processor-executable instructions when installed onto a system enable the system to perform actions, comprising:
receiving documents at a cloud processing arrangement;
rendering the documents into rasters at the cloud processing arrangement;
delivering the rasters to at least one printer of a local network;
monitoring delivery of the rasters; and
when delivery of the rasters fails to meet a threshold condition, diverting at least some portion of the documents to at least one server of the local network for rendering of those documents into rasters and for delivering those rasters to the at least one printer of the local network.

17. A system for managing printing of documents, the system comprising:
a local network comprising
at least one local device,
at least one printer,
at least one local server, and
at least one processor, the at least one processor is configured and arranged to
deliver documents from the at least one local device of the local network to a cloud processing arrangement external to the local network for rendering the documents into rasters at the cloud processing arrangement and delivering the rasters to the at least one printer of the local network;
monitor delivery of the rasters; and
when delivery of the rasters fails to meet a threshold condition, divert at least some portion of the documents to the at least one local server of the local network for rendering of those documents into rasters and for delivering those rasters to the at least one printer of the local network.

18. The system of claim 17, wherein the local network is a network of a print service provider.

19. A system for managing printing of documents, the system comprising:
a non-transitory memory storage device; and
at least one processor coupled to the memory storage device, the at least one processor is configured and arranged to
receive documents;
render the documents into rasters;
deliver the rasters to at least one printer of a local network, wherein the at least one processor of the system is external to the local network;
monitor delivery of the rasters; and
when delivery of the rasters fails to meet a threshold condition, divert at least some portion of the documents to at least one server of the local network for rendering of those documents into rasters and for delivering those rasters to the at least one printer.

20. The system of claim 19, wherein monitor delivery of the rasters comprises monitor a data rate of delivery of the rasters to the at least one printer.
